(19) United States
(12) Patent Application Publication
(10) Pub. No.: US 2024/0296025 A1
(43) Pub. Date: Sep. 5, 2024

(54) SYSTEMS AND METHODS TO GENERATE A DEVICE APPLICATION WITH MODULAR BUILDING BLOCKS

(71) Applicant: Engineer.ai Corp., Salt Lake City, UT (US)

(72) Inventors: Sachin Dev Duggal, Salt Lake City, UT (US); Joseph Rifkin, Salt Lake City, UT (US); Rohan Patel, London (GB)

(73) Assignee: Engineer.ai Corp., Salt Lake City, UT (US)

(21) Appl. No.: 18/178,482

(22) Filed: Mar. 3, 2023

(51) Int. Cl. G06F 8/35

(52) U.S. Cl. CPC G06F 8/35

(57) ABSTRACT

Systems, methods, and computer readable storage mediums for generating a software application are disclosed. A method includes constructing an application from one or more building blocks, each building block comprising one or more functions that are configured to operate independently of the other building blocks. The method further includes determining one or more connections between the one or more building blocks. The method further includes determining one or more connections between the one or more building blocks.

### FIELD OF THE INVENTION

This disclosure relates to software automation, machine learning AI, and project management.

### BACKGROUND

Software applications take considerable expertise and resources to develop. For commercial use, a software application should be designed to work with multiple hardware configurations. Further, many software applications must be configured to connect to an online server to perform various processes. For example, a shopping application may be configured to allow a user to login to a user account on a server, select various products or services, and purchase the selected products or services. Each step that the shopping application performs may require one or more separate sets of functions or modules to perform the step.

As such, even experienced developers may take a significant amount of time to develop any software application. There is a need in the art to simplify software application development to decrease the amount of time that software applications take to develop and to decrease the cost of development as well.

### SUMMARY

The disclosed subject matter includes systems, methods, and computer readable storage mediums for generating a software application. A method includes determining one or more features for the software application. The method further includes determining, for each of the one or more features, one or more building blocks to construct the feature. Each of the one or more building blocks include one or more functions that are configured to be performed by the building block independent of other building blocks in the software application and one or more adaptors that are configured to transmit messages to and from the building block. Each of the one or more adaptors may include a customizable portion that can be modified without changing the one or more functions of the building block. The customizable portion may be configured to include customizable logic that is triggered by the messages. The method may further include subscribing to one or more subscribing messages, the subscribing comprising creating customizable logic in at least one of the one or more adaptors to trigger one or more functions of the building block responsive to receiving the subscribing message. The method may further include configuring the at least one of the one or more adaptors to transmit an outgoing message to a run engine. The outgoing message may include the subscribing message. The method may further include transmitting messages via a run engine where the message is configured to be received by the one or more adaptors.

Another general aspect is a computer system to generate a software application. The computer system includes a processor coupled to a memory, the processor configured to execute a software to perform determine one or more features for the software application and determine, for each of the one or more features, one or more building blocks to construct the feature. Each of the one or more building blocks includes one or more functions that are configured to be performed by the building block independent of other building blocks in the software application and one or more adaptors that are configured to transmit messages to and from the building block. Each of the one or more adaptors may include a customizable portion that can be modified without changing the one or more functions of the building block. The customizable portion may be configured to include customizable logic that is triggered by the messages. The processor may be further configured to subscribe to one or more subscribing messages, the subscribing including creating customizable logic in at least one of the one or more adaptors to trigger one or more functions of the building block responsive to receiving the subscribing message. The processor may be further configured to configure at least one of the one or more adaptors to transmit an outgoing message to a run engine. The outgoing message may include the subscribing message. The processor may be further configured to transmit messages via a run engine, the message configured to be received by the one or more adaptors.

An exemplary embodiment is a computer readable storage medium having data stored therein representing software executable by a computer. The software includes instructions that, when executed, cause the computer readable storage medium to perform determining one or more features for the software application and determining, for each of the one or more features, one or more building blocks to construct the feature. Each of the one or more building blocks includes one or more functions that are configured to be performed by the building block independent of other building blocks in the software application and one or more adaptors that are configured to transmit messages to and from the building block. Each of the one or more adaptors may include a customizable portion that can be modified without changing the one or more functions of the building block. The customizable portion may be configured to include customizable logic that is triggered by the messages. The instructions may further cause the computer readable storage medium to perform subscribing to one or more subscribing messages, the subscribing comprising creating customizable logic in at least one of the one or more adaptors to trigger one or more functions of the building block responsive to receiving the subscribing message. The instructions may further cause the computer readable storage medium to perform configuring at least one of the one or more adaptors to transmit an outgoing message to a run engine. The outgoing message may include the subscribing message. The instructions may further cause the computer readable storage medium to perform transmitting messages via a run engine, the message configured to be received by the one or more adaptors.

Another general aspect is a method for generating a software application. The method includes constructing an application from one or more building blocks, each building block including one or more functions that are configured to operate independently of the other building blocks. The method further includes determining one or more connections between the one or more building blocks and creating one or more adaptors that perform the one or more connections. The one or more adaptors may be configured to perform the one or more connections by sending messages through a run engine. The messages may be configured to activate functions on one or more building blocks. The messages may be further configured to transmit data to one or more building blocks. At least one of the building blocks may be formed from a plurality of building blocks. The connections may be determined by a machine learning algorithm. The messages may be configured to activate functions on one or more building blocks where the messages are configured to activate functions on one or more building blocks.

An exemplary embodiment is a computer system to generate a software application. The computer system includes a processor coupled to a memory. The processor is configured to execute a software to perform constructing an application from one or more building blocks, each building block comprising one or more functions that are configured to operate independently of the other building blocks, determining one or more connections between the one or more building blocks, and creating one or more adaptors that perform the one or more connections. The one or more adaptors may be configured to perform the one or more connections by sending messages through a run engine. The messages may be configured to activate functions on one or more building blocks. The messages may be further configured to transmit data to one or more building blocks. At least one of the building blocks may be formed from a plurality of building blocks. The connections may be determined by a machine learning algorithm. The messages may be configured to activate functions on one or more building blocks where the messages are configured to activate functions on one or more building blocks.

Another general aspect is a computer readable storage medium having data stored therein representing software executable by a computer. The software includes instructions that, when executed, cause the computer readable storage medium to perform constructing an application from one or more building blocks, each building block including one or more functions that are configured to operate independently of the other building blocks. The instructions further cause the computer readable storage medium to perform determining one or more connections between the one or more building blocks and creating one or more adaptors that perform the one or more connections. The one or more adaptors may be configured to perform the one or more connections by sending messages through a run engine. The messages may be configured to activate functions on one or more building blocks. The messages may be further configured to transmit data to one or more building blocks. At least one of the building blocks may be formed from a plurality of building blocks. The connections may be determined by a machine learning algorithm.

Another exemplary embodiment is a method for generating a software application. The method includes determining one or more functions to implement the software application and selecting one or more building blocks, that contain one or more of the one or more functions where each of the one or more building blocks is configured to operate independently of one another. The method further includes determining connections, between the one or more building blocks, that are required to implement the software application and configuring one or more adaptors to implement the connections between the one or more building blocks. The method may further include subscribing, by the one or more adaptors, to receive messages based on the connections. At least one of the one or more adaptors may be configured to broadcast messages to the application based on a functionality of a building block. The subscribing may include listening, by the one or more adaptors, for a message where the one or more adaptors are configured to execute at least one of the one or more functions responsive to a reception of the message. At least one of the one or more functions may be configured to receive data from the message. At least one of the building blocks may be formed from a plurality of building blocks. Determining connections may include using a machine learning algorithm to create one way messaging links between the one or more building blocks.

Another general aspect is a computer system to generate a software application. The computer system includes a processor coupled to a memory. The processor is configured to execute software to perform determining one or more functions to implement the software application and selecting one or more building blocks, that contain the one or more functions, each of the one or more building blocks configured to operate independently of one another. The processor may be configured to execute software to further perform determining connections, between the one or more building blocks, that are required to implement the software application and configuring one or more adaptors to implement the connections between the one or more building blocks. The processor may be further configured to subscribe, by the one or more adaptors, to receive messages based on the connections. At least one of the one or more adaptors may be configured to broadcast messages to the application based on a functionality of a building block. The subscribing may include listening, by the one or more adaptors, for a message where the one or more adaptors are configured to execute at least one of the one or more functions responsive to a reception of the message. At least one of the one or more functions may be configured to receive data from the message. At least one of the building blocks may be formed from a plurality of building blocks. Determining connections may include using a machine learning algorithm to create one way messaging links between the one or more building blocks.

An exemplary embodiment is a computer readable storage medium having data stored therein representing software executable by a computer. The software includes instructions that, when executed, cause the computer readable storage medium to perform determining one or more functions to implement the software application and selecting one or more building blocks, that contain the one or more functions where each of the one or more building blocks are configured to operate independently of one another. The software instructions further cause the computer readable storage medium to perform determining connections, between the one or more building blocks, that are required to implement the software application and configuring one or more adaptors to implement the connections between the one or more building blocks. The instructions may further cause the computer readable storage medium to perform subscribing, by the one or more adaptors, to receive messages based on the connections. At least one of the one or more adaptors may be configured to broadcast messages to the application based on a functionality of a building block. The subscribing may include listening, by the one or more adaptors, for a message where the one or more adaptors are configured to execute the one or more functions responsive to a reception of the message. At least one of the one or more functions may be configured to receive data from the message. Determining connections may include using a machine learning algorithm to create one way messaging links between the one or more building blocks.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6A is a schematic for an embodiment of a run engine of the disclosed subject matter.

FIG. 6B is a schematic for an embodiment of a building block that may be implemented in the disclosed subject matter.

FIG. 6C is a schematic for an embodiment of an adapter that may be implemented in the disclosed subject matter.

FIG. 7 is a schematic for an embodiment of a building block that comprises multiple building blocks.

FIGS. 8A-8C are flow diagrams for embodiments of processes of generating a software application using building blocks.

FIGS. 9A-9C are illustrations of device screens that are running a software application comprising building blocks.

### DETAILED DESCRIPTION

The disclosed subject matter comprises systems and methods for generating a software application using building blocks. The building blocks may be modules or components that are self-contained and operate independently of one another. Despite being configured to operate independently, the building blocks may be configured to transmit messages and data to one another in the software application.

To facilitate communication between building blocks, the disclosed subject matter comprises one or more adapters that are configured to send and receive data. In an exemplary embodiment, a building block may comprise one or more functions that transmit a message to a run engine. An adapter may package the message to be transmitted to the run engine. Further, an adapter may be configured to listen for the transmitted message, which may implement one or more functions on another building block.

Accordingly, building blocks may be configured to operate independently of one another while adapters are configured to connect the building blocks in any way to build the software application. In an exemplary embodiment, a software application is built from preconfigured building blocks using custom logic that is implemented in adapters. In various embodiments, a controller may handle all logic between building blocks and adapters allowing developers to implement minimal coding. For instance, a developer may select one or more preconfigured building blocks, select one or more preconfigured adapters, and plug them into a software application. The developer may then implement logic in one or more controllers to facilitate the interactions between building blocks and adapters.

In various embodiments, a run engine may be implemented to facilitate the transmission of messages between building blocks and adapters. In an exemplary embodiment, the run engine is preconfigured for developers, which may allow the developer to focus only on logic and the controllers. In one example of use, a developer may select one or more features for a software application and determine one or more building blocks to implement the selected features. The developer may then determine adapters that may be needed to transmit messages between building blocks. After selecting the building blocks and adapters, the developer may code logic into the software application that determines an interaction between the building blocks and adapters.

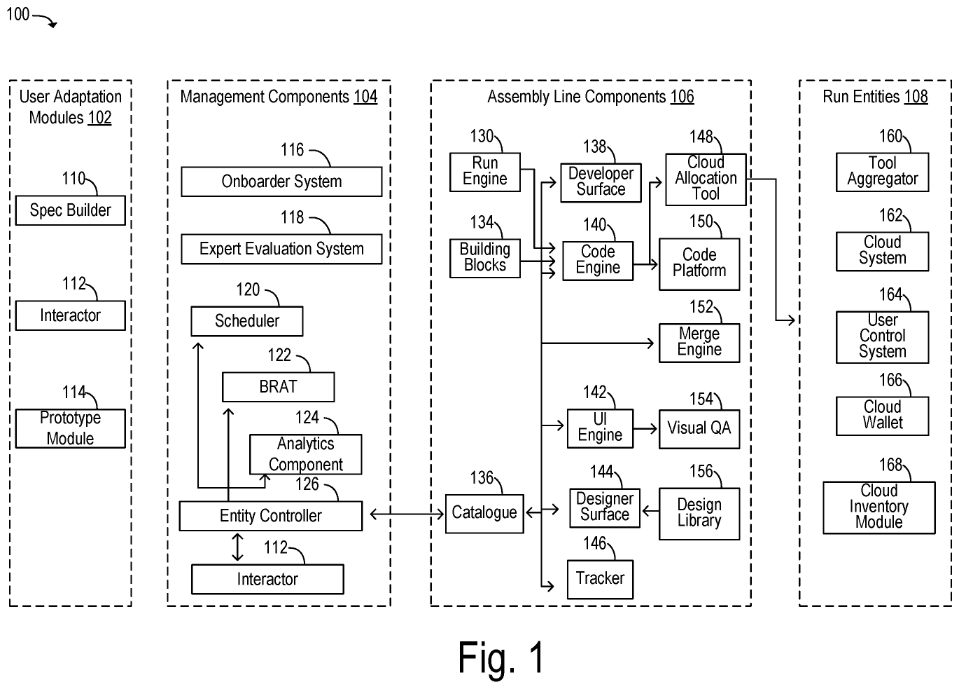

Referring to FIG. 1, FIG. 1 is a schematic of a software building system 100 illustrating the components that may be used in an embodiment of the disclosed subject matter. The software building system 100 is an AI-assisted platform that comprises entities, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may except plain language specifications from a user and convert them into a computer readable specification that can be implemented by other parts of the software building system 100. Various other entities of the software building system 100 may accept the computer readable specification or buildcard to automatically implement it and/or manage the implementation of the buildcard.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include Spec Builder 110, Interactor 112, and the prototype module 114. They may be used to guide a user through a process of building software and managing a software project. Spec Builder 110, Interactor 112, and the prototype module 114 may be used concurrently and/or link to one another. For instance, Spec Builder 110 may accept user specifications that are generated in Interactor 112. The prototype module 114 may utilize computer generated specifications that are produced in Spec Builder 110 to create a prototype for various features. Further, Interactor 112 may aid a user in implementing all features in Spec Builder 110 and the prototype module 114.

Spec Builder 110 converts user supplied specifications into specifications that can be automatically read and implemented by various entities of the software building system 100. The machine readable specifications may be referred to herein as a buildcard. In an example of use, Spec Builder 110 may accept a set of features, platforms, etc., as input and generate a machine readable specification for that project. Spec Builder 110 may further use one or more machine learning algorithms to determine a cost and/or timeline for a given set of features. In an example of use, Spec Builder 110 may determine potential conflict points and factors that will significantly affect cost and timeliness of a project based on training data.

Interactor 112 is an AI powered speech and conversational analysis system. It converses with a user with a goal of aiding the user in a specific way. In one example, the Interactor 112 system may ask the user a question to prompt the user to answer about a relevant topic. For instance, the relevant topic may relate to a structure and/or scale of a software project the user wishes to produce. The Interactor 112 system makes use of natural language processing (NLP) to decipher various forms of speech including comprehending words, phrases, and clusters of phases

In an exemplary embodiment, the NLP implemented by Interactor 112 is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as a Sigmoid function. Further, each synapse has a weight that is determined by training the neural network. A common method of training a neural network is backpropagation.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by Interactor 112 may output the meaning of words and phrases that are communicated by the user. The Interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarder system 116, an expert evaluation system 118, Scheduler 120, BRAT 122, analytics component 124, entity controller 126, and Interactor 112.

The onboarder system 116 aggregates experts so they can be utilized to execute specifications that are set up in the software building system 100. In an exemplary embodiment, software development experts may register into the onboarder system 116 which will organize experts according to their skills, experience, and past performance. In one example, the onboarder system 116 provides the following features: partner onboarding, expert onboarding, reviewer assessments, expert availability management, and expert task allocation.

An example of partner onboarding may be pairing a user with one or more partners in a project. The onboarder system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarder system 116 to automatically review completed portions of a project. For instance, the onboarder system 116 may analyze submitted code, validate functionality of submitted code, and assess a status of the code repository. An example of expert availability management in the onboarder system 116 is to manage schedules for expert assignments and oversee expert compensation. An example of expert task allocation is to automatically assign jobs to experts that are onboarded in the onboarder system 116. For instance, the onboarder system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarder system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The Big Resource Allocation Tool (BRAT 122) is capable of generating optimal developer assignments for every available parallel workstream across multiple projects. BRAT 122 allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. BRAT 122 may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to Scheduler 120, BRAT 122, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to Interactor 112, allowing users to interact with a live project via an intelligent AI conversational system. Further, Interactor 112 may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building blocks 134, catalogue 136, developer surface 138, a code engine 140, a UI engine 142, a designer surface 144, tracker 146, a cloud allocation tool 148, a code platform 150, a merge engine 152, Visual QA 154, and a design library 156.

The run engine 130 may maintain communication between various building blocks within a project as well as outside of the project. In an exemplary embodiment, the run engine 130 may send HTTP/S GET or POST requests from one page to another.

The building blocks 134 are reusable code that are used across multiple buildcards. Buildcards are machine readable specifications that are generated by Spec Builder 110, which may convert user specifications into a buildcard that contains the user specifications and a format that can be implemented by an automated process with minimal intervention by expert developers.

The buildcards are constructed with building blocks 134, which are reusable code components. The building blocks 134 may be pretested code components that are modular and safe to use. In an exemplary embodiment, every building block 134 consists of two sections—core and custom. Core sections comprise the lines of code which represent the main functionality and reusable components across buildcards. The custom sections comprise the snippets of code that define customizations specific to the buildcard. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building blocks required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associate with buildcards. For example, the cloud allocation tool 148 assesses buildcards to predict a cost and resources to complete them. The cloud allocation tool 148 then creates cloud accounts based on the prediction and facilitates payments over the lifecycle of the buildcard.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the Visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by Scheduler 120 so they can be reviewed by expert developers.

In an exemplary embodiment, Visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The Visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, buildcards include prompts to insert designs. Based on the buildcard, the designer surface 144 informs designers of designs that are expected of them and provides for easy submission of designs to the buildcard. Submitted designs may be immediately available for further customization by expert developers that are connected to a project network.

Similar to building blocks 134, the design library 156 contains design components that may be reused across multiple buildcards. The design components in the design library 156 may be configured to be inserted into buildcards, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, Spec Builder 110, Interactor 112, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building blocks 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a buildcard. This is achieved by consuming data from multiple cloud providers and converting it to domain specific language, which allows the cloud allocation tool 148 to predict infrastructure blueprints for customers' buildcards in a cloud agnostic manner. It manages the infrastructure for the entire lifecycle of the buildcard (from development to after care) which includes creation of cloud accounts, in predicted cloud providers, along with setting up CI/CD to facilitate automated deployments.

The cloud inventory module 168 handles storage of assets on the run entities 108. For instance, building blocks 134 and assets of the design library are stored in the cloud inventory entity. Expert developers and designers that are onboarded by onboarder system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

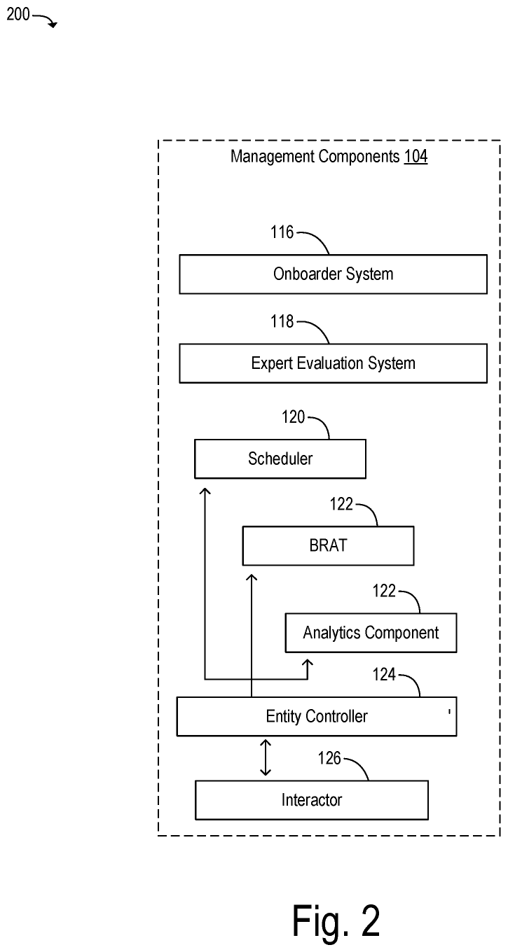

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display buildcards configurations, provide statuses of all buildcards, provide toolkits within each buildcard, integration of the entity controller 126 with tracker 146 and the onboarder system 116, integration code repository for repository creation, code infrastructure creation, code management, and expert management, customer management, team management, specification and demonstration call booking and management, and meetings management.

In an exemplary embodiment, the buildcard configuration status includes customer information, requirements, and selections. The statuses of all buildcards may be displayed on the entity controller 126, which provides a concise perspective of the status of a software project. Toolkits provided in each buildcard allow expert developers and designers to chat, email, host meetings, and implement 3rd party integrations with users. Entity controller 126 allows a user to track progress through a variety of features including but not limited to tracker 146, the UI engine 142, and the onboarder system 116. For instance, the entity controller 126 may display the status of buildcards as displayed in tracker 146. Further, the entity controller 126 may display a list of experts available through the onboarder system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into Scheduler 120 to determine a timeline for jobs to be completed by developer experts and designers. The BRAT 122 system may be leveraged to score and rank experts for jobs in Scheduler 120. A user may interact with the various entity controller 126 features through the analytics component 124 dashboard. Alternatively, a user may interact with the entity controller 126 features via the interactive conversation in Interactor 112.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

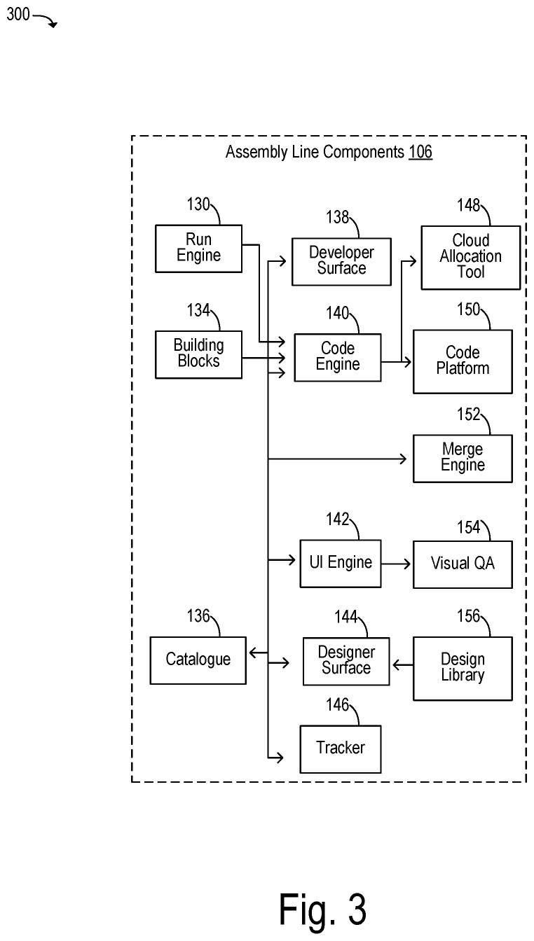

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building blocks. The building blocks contain LSTs that identify the customizable portions of the building blocks 134.

Buildcards may be generated from user specifications. Like the building blocks, the buildcards are designed to be managed by a user without software management experience. The buildcards specify project goals that may be implemented automatically. For instance, the buildcards may specify one or more goals that require expert developers. The Scheduler 120 may hire the expert developers based on the buildcards or with direction from the user. Similarly, one or more designers may be hired based on specifications in a buildcard. Users may actively participate in management or take a passive role.

A cloud allocation tool 148 is used to determine costs for each buildcard. In an exemplary embodiment, a machine learning algorithm is used to assess buildcards to estimate costs of development and design that is specified in a buildcard. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in buildcards. Thus, designers may be hired and provided with instructions to complete a design by an automated system that reads a buildcard and hires out designers based on the specifications in the buildcard. Designers may have access to pretested design components from a design library 156. The design components, like building blocks, allow the designers to start a design from a standardized design that is already functional.

The UI engine 142 may automatically convert designs into web ready code such as React code that may be viewed by a web browser. To ensure that the conversion process is accurate, the Visual QA 154 system may evaluate screens generated by the UI engine 142 by comparing them with the designs that the screens are based on. In an exemplary embodiment, the Visual QA 154 system does a pixel to pixel comparison and logs any discrepancies to be evaluated by an expert developer.

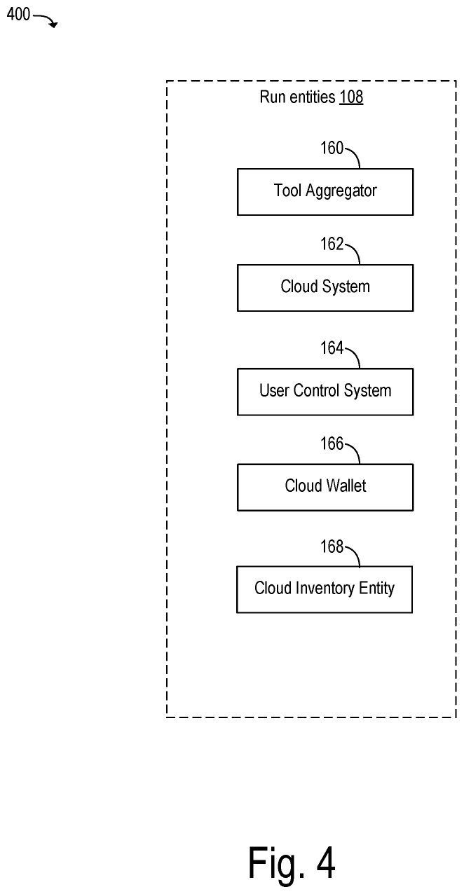

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in Interactor 112, providing user specifications that are converted into buildcards, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

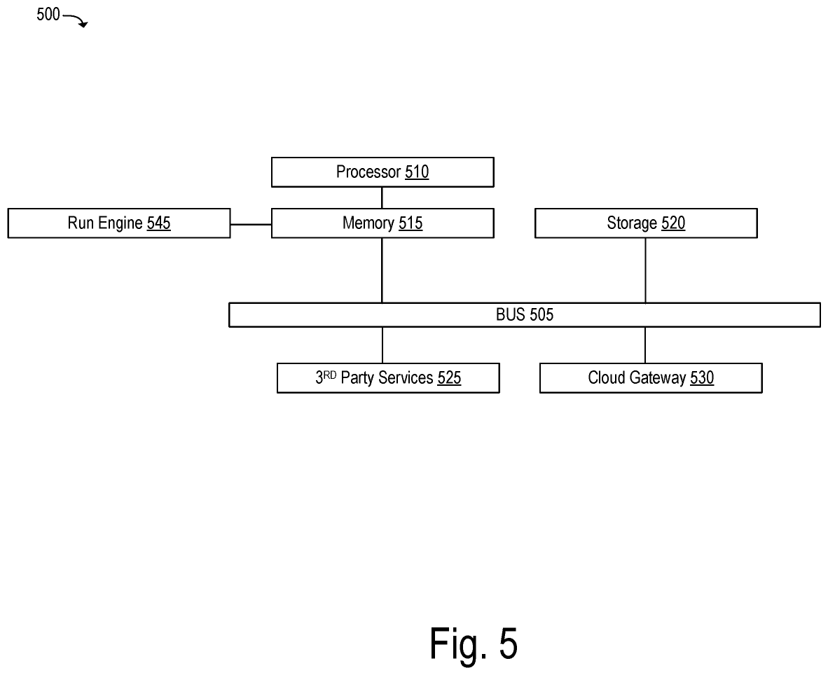

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, one or more processors 510 connected to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The memory 515 may store one or more applications that run time. For example the memory 515 may store the run engine 545 of the disclosed subject matter. An exemplary embodiment, run engine 545 may facilitate messages between various components of an application. For example, one or more building blocks of an application may transmit messages via the run engine 545. The memory 515, coupled to the processor 510, facilitates execution of messages in the application.

The storage 520 is intended for long term data storage. Data in the software project such as buildcards, code, designs, and the like may be saved in a storage 520. The storage 520 may be stored at any location including in the cloud. Various types of storage include spinning magnetic drives and solid-state storage drives. In various embodiments, the software application may be stored in the storage 520. To run the application, a user may execute a command to transfer the application from the storage to the memory to run the application.

The computing system 500 may connect to other computing systems in the performance of a software project. For instance, the computing system 500 may send and receive data from 3rd party services such as Office 365 and Adobe. Similarly, users may access the computing system 500 via a cloud gateway 530. For instance, a user on a separate computing system may connect to the computing system 500 to access data, interact with the run entities 108, and even use 3rd party services 525 via the cloud gateway.

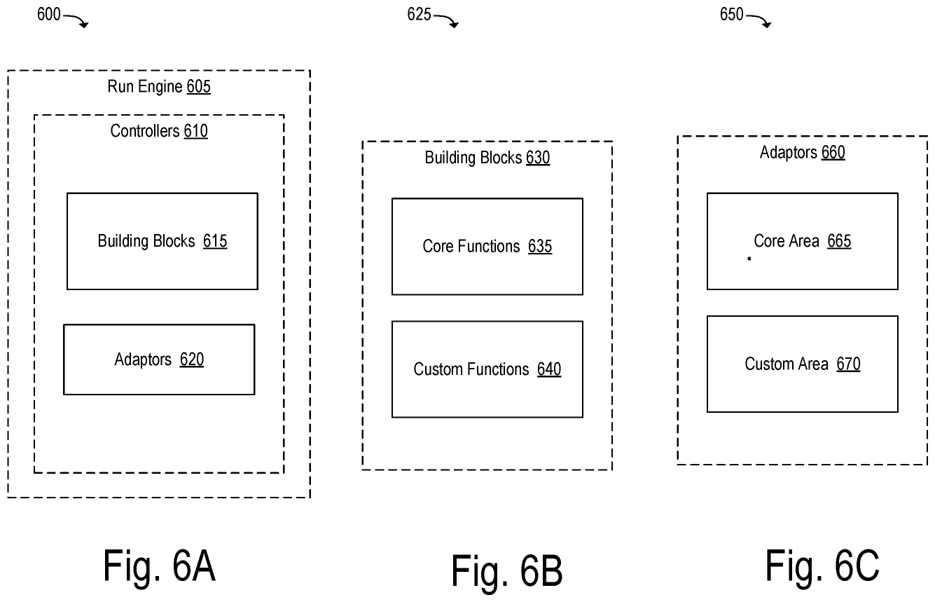

Referring to FIG. 6A, FIG. 6A is a schematic 600 for an embodiment of a run engine 605 of the disclosed subject matter. The run engine 605 facilitates the transmission of messages within the software application. Building blocks 615 that make up core features of a software application are operated by the run engine 605. In various embodiments, a developer may select a multitude of building blocks depending on features that are desired for the software application. The run engine 605 may contain any number of building blocks 615 to implement any number of features.

In an exemplary embodiment, the run engine 605 comprises one or more controllers 610. Each controller 610 may comprise one or more building blocks 615 and one or more adapters 620. The controller 610 may include logic that determines an interaction between building blocks 615. For instance, a controller 610 may comprise a building block 615 that includes the functions for logging a user into a server. Logic in the controller 621 may determine when those functions are implemented. Logic in the controller may also help determine one or more functions that are implemented after the login is implemented.

The building blocks 615 are software modules that comprise one or more functions for implementing features in a software application. Each building block 615 in the controller 610 may operate independently of each other building block 615 in the controller 610. Accordingly, removing or adding one or more building blocks 615 from the controller 610 or from the software application does not impact a functionality of the other building blocks 615 in the software application or controller 610. Accordingly, building blocks 615 may be developed in any order or in parallel in a software application. For instance, multiple developers may concurrently develop one or more building blocks 615 for the same software application.

The controller 610 may include one or more adapters 620 that enable the sending and receiving of messages to and from building blocks 615. Building blocks 615 may communicate with other building blocks via the sending of messages. Adapters 620 may be used to generate messages based on output from a building block 615. Adapters 620 may also be used to receive messages for one or more building blocks 615. A single adapter 620 may be implemented to send and receive messages for one or more building blocks 615.

In an example of use, when a building block 615, which is configured to log a user into an application, completes a login, an adapter 620 may be configured to broadcast a message that a login is complete. Another building block 615, which is configured to open a startup screen may be activated based on the login complete message. Accordingly, an adapter may receive the login complete message and activate a building block 615 to open the start of screen.

Referring to FIG. 6B, FIG. 6B is a schematic 625 for an embodiment of a building block 630 that may be implemented in the disclosed subject matter. A software application may include one or more building blocks 630. Each building block 630 operates independently of the other building blocks 630, but may be configured to send and receive messages to and from the other building blocks 630.

Each building block 630 comprises software functions that enable one or more features in the software application. For instance, a building block 630 for implementing a clickable button may include one or more functions, that when executed, implement a clickable button utility. Each building block 630 may comprise one or more core functions 635 and one or more custom functions 640. The core functions 635 may be configured to be un-editable in a building block 630. A developer may be encouraged to include one or more custom functions 640 in a building block 630 to implement functionality or features that are specific to their software application.

Each of the core functions 635 and custom functions 640 may be configured so as not to depend on functionality from other building blocks 630. Thus, each of the building blocks 630 may be developed independently. This may allow for rapid development as building blocks 630 may be developed concurrently by multiple developers. Further, building blocks 630 may be configured to implement specific features in an application that are common to multiple applications.

Thus, a single building block 630 may be developed to be used as a utility. A developer may choose to include a preconfigured building block 630 based on features that the developer desires in the software application. A completed software application may be further developed by adding additional building blocks 630 because the additional building blocks 630 do not depend on any of the existing building blocks 630. Further, adding additional building blocks to a software application will not break any of the functionality of the software application.

Referring to FIG. 6C, FIG. 6C is a schematic 650 for an embodiment of an adapter 660 that may be implemented in the disclosed subject matter. Building blocks 630 do not depend on any functions of other building blocks 630. However, a building block may be configured to receive messages that are generated by another building block 630. The transmission of messages from one building block 630 to another is facilitated by the adapters 660.

Adapters 660 allow for building blocks 630 to be interconnected without being interdependent on functionality. A building block 630 may generate a message that is to be received by another building block 630. An adapter 660 may be configured to broadcast a message from one building block 630 and another adapter 660 may be configured to listen for the message. For example, the adapter 660 may be configured to subscribe to one or more messages, where subscribing puts the adapter in a state that causes the adapter 660 to perform an action when it receives the message. The terms listening and subscribing, as used herein, are used interchangeably as they apply to the adapters 660.

In various embodiments, an adapter may be configured to broadcast data that is nested in a message. For instance, an adapter may broadcast a message to open a check out screen for a shopping application. The message to open the check out screen may be received by an adapter 660 that executes one or more functions on a building block 630 that operates the checkout screen. The message may further include nested data such as one or more shopping items that the user selected. The nested data may be received by the adapter 660 along with the message to be transmitted to the building block 630 that implements the checkout screen.

Like building blocks 630, the adapters 660 may each include a core area 665 and a custom area 670. The core area 665 may include one or more functions that facilitate sending and receiving messages with the adapter 660. In various embodiments, an adapter may have a listen function whereby any adapter may be configured to listen for one or more messages that may be transmitted within the run engine 605. In an example of use, an adapter 660 is configured to listen for a login complete message. When the adapter 660 receives the login complete message, it executes one or more functions in a building block 630.

The custom area 670 and each adapter 660 may be utilized to implement logic in a software application. For example, the custom area may be edited to execute one or more functions of a building block upon receiving a message from the run engine 605. In another example, logic may be implemented to broadcast one or more messages responsive to execution of functions in a building block 630.

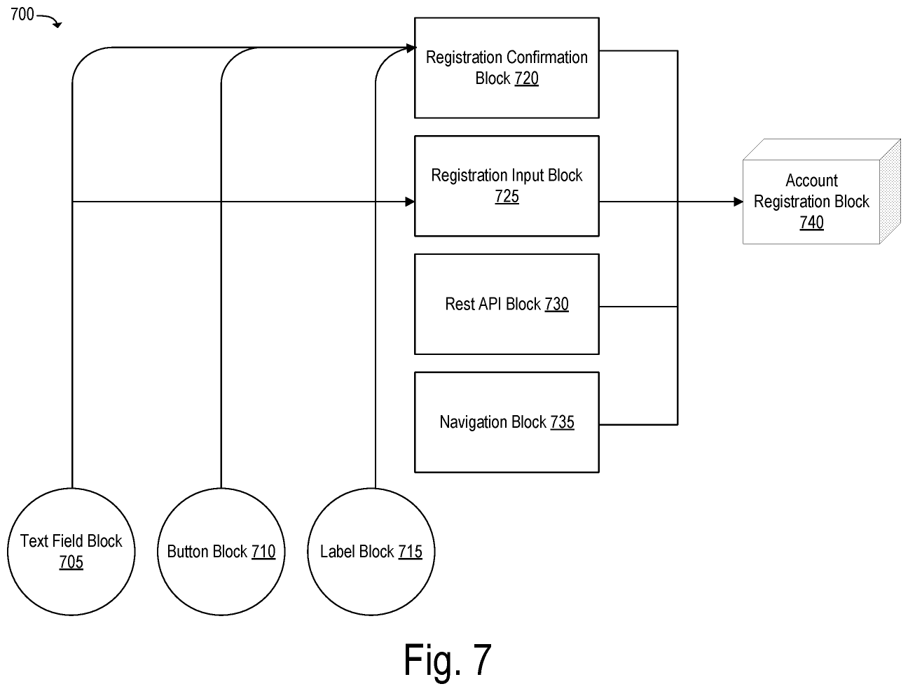

Referring to FIG. 7, FIG. 7 is a schematic 700 for an embodiment of a building block that comprises multiple building blocks. In the disclosed subject matter, building blocks are software modules that may be combined into a composite building block. In the exemplary embodiment shown in the schematic 700, an account registration block 740 is a building block that comprises four smaller building blocks. As shown in FIG. 7, the account registration block 740 comprises a registration confirmation block 720, a registration input block 725, a rest API block 730, and a navigation block 735.

The various building blocks that make up the account registration block 740 may be configured to receive various messages and/or data via the run engine 605. In the example shown in the schematic 700, the account registration block 740 is configured to receive messages and/or data from a text field block 705, a button block 710, and a label block 715. For example, the text field block 705 may create a message, via an adapter 660, that includes nested text field data. The text field data may be received by a registration confirmation block 720 and a registration input block 725. In an example of use, the registration input block 725 may receive text field data as input for a registration, and the registration confirmation block 720 may be configured to receive a message that indicates that a text field was input into the registration.

Similarly, the registration confirmation block 720 and registration input block 725 may be configured to receive messages and/or data from the button block 710 and label block 715. In an example of use for the button block 710, both the registration confirmation block 720 and registration input block 725 may be configured to listen for a message that the button block 710 broadcasts responsive to a button being depressed.

An example of use for the label block 715, the registration confirmation block 720 and registration input block 725 may be configured to receive image data nested in a message that is broadcast from a label block 715. For instance, a label block may contain an image that depicts a check mark that indicates a registration is complete. The checkmark image may be nested in a message that is broadcast from the label block 715. The checkmark image may be received by an adapter that is listening for a message from the label block 715. The adapter may then transmit the image data nested within the message to the registration confirmation block 720 and registration input block 725.

The rest API block 730 may include one or more functions that allow a user or developer to access functions in the account registration block 740. The navigation block 735 may include one or more functions to allow a user to navigate to various screens for an account registration.

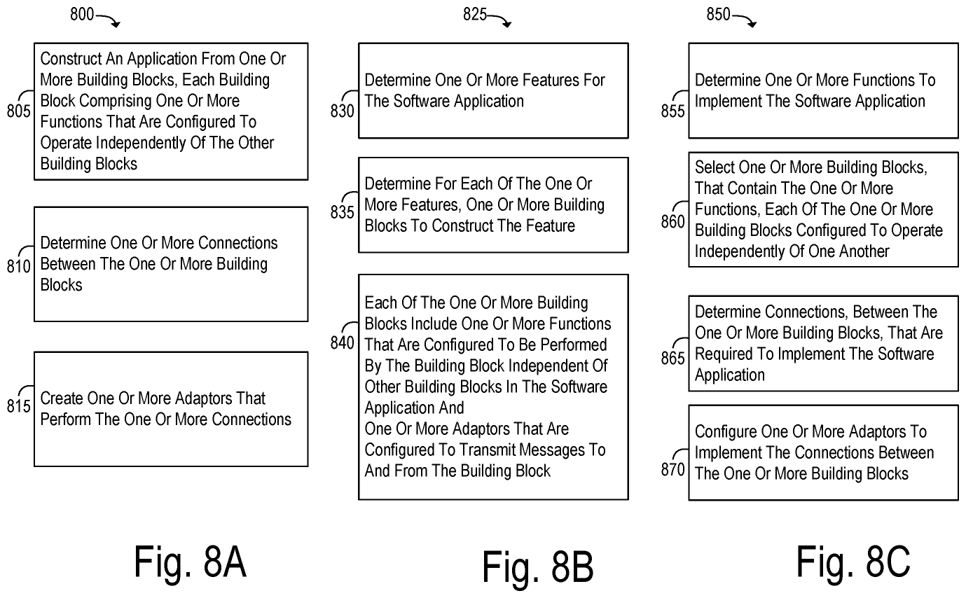

Referring to FIG. 8A, FIG. 8A is a flow diagram 800 for an embodiment of a process of generating a software application using building blocks. The process may be utilized by one or more developers to develop a software application. The process is configured such that one or more building blocks, which comprise the core functions of the software application, may be developed independently of one another. Accordingly, one or more developers may work on portions of the software application independently of one another. In various embodiments, software developers may work on an application without any coordination or even awareness of one another. One or more software developers may develop multiple building blocks of the disclosed subject matter concurrently or at different times.

At step 805, the process may construct an application from one or more building blocks, each building block comprising one or more functions that are configured to operate independently of the other building blocks. In an exemplary embodiment, the building blocks are organized such that each building block contributes a core functionality that is desired for the software application. Any number of building blocks, and thus any number of core functionalities, may be added to the software application.

At step 810, the process may determine one or more connections between the one or more building blocks. The connections may comprise any communication between building blocks that is desired. For example, when a 1^{st} building block for a 1^{st} functionality complete a task, it may be configured to send a message to a 2^{nd} building block for a 2^{nd} functionality. The process may determine that the 1^{st} building block should be connected to the 2^{nd} building block. That does not mean that the 2^{nd} building block is dependent on the 1^{st} building block. Instead, the 1^{st} building block may be configured to broadcast a message that can be received by the 2^{nd} building block. The 2^{nd} building block may be configured to receive the broadcasted message.

In various embodiments, the connections may be determined by a machine learning algorithm that is trained based on established connections between building blocks in other software applications. In an exemplary embodiment, a classification machine learning algorithm is leveraged to determine likely connections between the building blocks. Examples of classification machine learning algorithms include decision trees, gradient boosting, and neural networks. Connections between building blocks may be configured to be in one direction where a 1^{st} building block always sends and a 2^{nd} building block aways receives. The term one-way, as used herein, refers to the a connection that operates in one direction.

At step 815, the process may create one or more adapters that perform the one or more connections. The adapters may facilitate the sending of and receiving of messages to and from the building blocks. In the example given in the previous paragraph, a 1^{st} adapter for the 1^{st} building block may serialize a message indicating that the 1^{st} functionality is complete. The 1^{st} adapter may then broadcasts the message to the run engine. A 2^{nd} adapter for the 2^{nd} building block may be configured to listen for the broadcasted message. When the message is broadcasted, the 2^{nd} adapter may receive it and implement one or more functions in the 2^{nd} building block.

Referring to FIG. 8B. FIG. 8B is another flow diagram 825 for an embodiment of a process of generating a software application using building blocks. At step 830, the process may determine one or more features for the software application. For example, a shopping application may require a user to browse one or more products or services, select the one or more products or services, and to purchase the selected products or services. The process may determine features that enable the shopping application.

At step 835, the process may determine, for each of the one or more features, one or more building blocks to construct the feature. In an exemplary embodiment, each feature may be constructed from one or more building blocks. Alternatively, a single building block may enable more than one feature. In the example given in the previous paragraph for a shopping application, the feature that allows a user to browse one or more products and services may include a building block that displays the one or more products on a screen, a building block that allows scrolling through the one or more products or services, and a building block that allows a user to view an image of the one or more products or services.

At step 840, each of the one or more building blocks include one or more functions that are configured to be performed by the building block independent of other building blocks in the software application and one or more adapters that are configured to transmit messages to and from the building block. As described above, the building blocks include functions that perform the desired features for the software application. Communication between building blocks may be performed by the one or more adapters. Each adapter may be configured to send or receive messages to and from the building blocks.

Referring to FIG. 8C. FIG. 8C is yet another flow diagram 850 for an embodiment of a process of generating a software application using building blocks. At step 855, the process may determine one or more functions to implement the software application. For instance, if a software application requires a 1^{st} feature, a 2^{nd} feature, and a 3^{rd} feature, the process may determine functions to implement the features. For instance, if a 1^{st} feature is a clickable button, the process may determine functions that display an image of a button and activate a call back when the button is clicked.

At step 860, the process may select one or more building blocks that contain the one or more functions where each of the one or more building blocks are configured to operate independently of one another. Accordingly, one or more functions in a 1^{st} building block are not dependent on one or more functions of a 2^{nd} building block. However, the functions in the 2^{nd}building block may be configured to accept data that is nested in a message that is broadcasted by the 1^{st} building block. As used herein, the broadcasting of a message by a building block refers to an adapter that broadcasts a message responsive to activating a function in a building block.

At step 865, the process may determine connections, between the one or more building blocks, that are required to implement the software application. In the example given in the previous paragraph, the process may determine that the 1^{st} building block should be connected to the 2^{nd} building block. Not every building block will need to be connected to another building block. Alternatively, one building block may be connected to multiple building blocks. The connections may be one way or both ways.

At step 870, the process may configure one or more adapters to implement the connections between the one or more building blocks. In the example given in the previous paragraph, a 1^{st} adapter may be configured to broadcast a message from the 1^{st} building block. In one implementation, the 1^{st} building block may execute a function that operates the 1^{st} adapter. In another implementation, the controller 610 executes a function in the 1^{st} adapter to broadcast a message when the 1^{st} building block completes a process. A 2^{nd} adapter may be configured to listen for the broadcast from the 1^{st} adapter. More than one adapter may be configured to listen for the broadcast from the 1^{st} adapter. The 2^{nd} adapter may implement one or more functions on the 2^{nd} building block responsive to receiving the broadcasted message. Further, the 2^{nd} adapter may implement one or more functions on additional building blocks responsive to receiving the broadcasted message.

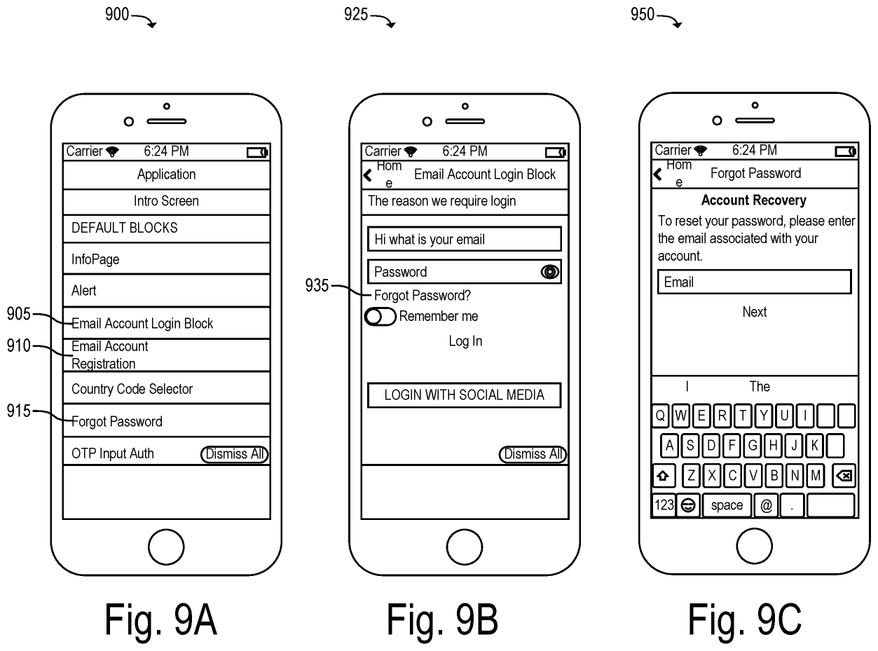

Referring to FIGS. 9A-9C, FIG. 9A is an illustration of a device screen 900 that is running a software application comprising building blocks. The device screen 900 displays textual data on a grid. Some of the textual data is implemented as a clickable button that activates one or more functions when clicked. The clickable buttons may comprise one or more building blocks. Further, each clickable button may, when clicked, execute a process that includes broadcasting a message that implements another building block.

For example, the email account login block 905, when clicked, activates a navigation to an email login screen 925. Accordingly, when a user clicks the email account login block 905, an adapter may broadcast a message to open the email login screen 925, which is shown in FIG. 9B. A building block that implements the email login screen 925 may receive the message via an adapter.

Likewise, the email account registration 910 is a clickable button that, when clicked, activates a navigation to an email account registration screen. The email account registration 910 button may be configured to broadcast a message that, when received, implements a building block that navigates a user to the email account registration screen. The message may also activate one or more functions on a building block that controls the email account registration screen. In various embodiments, implementation of messages may be controlled by a controller 610. The logic associated with the broadcasting of messages and connecting various functions to messages may also be handled by a controller and/or adapters.

The forgot password 915 text is a clickable button that, when activated by a user, navigates a user to a forgot password screen 950. Likewise, the “Forgot Password?” 935 text in FIG. 9B may also navigate a user to a forgot password screen 950, which is illustrated in FIG. 9C. Accordingly, clicking both forgot password 915 and the “Forgot Password?” 935 text may cause a building block, function, adapter, or controller to broadcast a message that, when received, activates a navigation to the forgot password screen 950. As demonstrated, multiple buttons and/or building block functions may implement the same messages.

The term function, as used herein may refer to any sequence of instructions that perform a task. The term function, as used herein, may refer to any function, subroutine, module, class, entity, component, or the like in a software environment.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for generating a software application, the method comprising:
constructing an application from one or more building blocks, each building block comprising one or more functions that are configured to operate independently of each of the other building blocks;
determining one or more connections between the one or more building blocks; and
creating one or more adaptors that perform the one or more connections.

2. The method of claim 1, wherein the one or more adaptors are configured to perform the one or more connections by sending messages through a run engine.

3. The method of claim 2, wherein the messages are configured to activate functions on one or more building blocks.

4. The method of claim 2, wherein the messages are further configured to transmit data to one or more building blocks.

5. The method of claim 2, wherein at least one of the building blocks is formed from a plurality of building blocks.

6. The method of claim 2, wherein the connections are determined by a machine learning algorithm.

7. The method of claim 6, wherein the messages are configured to activate functions on one or more building blocks; and
wherein the messages are configured to activate functions on one or more building blocks.

8. A computer system to generate a software application, the computer system comprising:
a processor coupled to a memory, the processor configured to execute a software to perform:
construct an application from one or more building blocks, each building block comprising one or more functions that are configured to operate independently of each of the other building blocks;
determine one or more connections between the one or more building blocks; and
create one or more adaptors that perform the one or more connections.

9. The computer system of claim 8, wherein the one or more adaptors are configured to perform the one or more connections by sending messages through a run engine.

10. The computer system of claim 9, wherein the messages are configured to activate functions on one or more building blocks.

11. The computer system of claim 9, wherein the messages are further configured to transmit data to one or more building blocks.

12. The computer system of claim 9, wherein at least one of the building blocks is formed from a plurality of building blocks.

13. The computer system of claim 9, wherein the connections are determined by a machine learning algorithm.

14. The computer system of claim 13, wherein the messages are configured to activate functions on one or more building blocks; and
wherein the messages are configured to activate functions on one or more building blocks.

15. A computer readable storage medium having data stored therein representing software executable by a computer, the software comprising instructions that, when executed, cause the computer readable storage medium to perform:
constructing an application from one or more building blocks, each building block comprising one or more functions that are configured to operate independently of each of the other building blocks;
determining one or more connections between the one or more building blocks; and
creating one or more adaptors that perform the one or more connections.

16. The computer readable storage medium of claim 15, wherein the one or more adaptors are configured to perform the one or more connections by sending messages through a run engine.

17. The computer readable storage medium of claim 16, wherein the messages are configured to activate functions on one or more building blocks.

18. The computer readable storage medium of claim 16, wherein the messages are further configured to transmit data to one or more building blocks.

19. The computer readable storage medium of claim 16, wherein at least one of the building blocks is formed from a plurality of building blocks.

20. The computer readable storage medium of claim 15, wherein the connections are determined by a machine learning algorithm.
